(19) United States
(12) Patent Application Publication
(10) Pub. No.: US 2020/0218928 A1
(43) Pub. Date: Jul. 9, 2020

(54) VALIDATION OF CANDIDATE LOCATIONS OF A BOUNDARY

(71) Applicant: HP Indigo B.V., Amstelveen (NL)

(72) Inventors: Eli Chen, Ness Ziona (IL); Oren Haik, Ness Ziona (IL); Oded Perry, Ness Ziona (IL)

(73) Assignee: HP Indigo B.V., Amstelveen (NL)

(21) Appl. No.: 16/632,564

(22) PCT Filed: Oct. 2, 2017
(86) PCT No.: PCT/EP2017/075010

§ 371 Date: Jan. 21, 2020

(51) Int. Cl. G06K 9/46; G06K 9/20; G06K 9/52

(52) U.S. Cl. CPC G06K 9/4604; G06K 9/52; G06K 9/2054

(57) ABSTRACT

A method is described in which an image is received, the image including a document and background area; a candidate location of a boundary between the document and the background area is found; and a validity of the candidate location of the boundary is checked, based on pixel values around the candidate location of a first channel of the image, and pixel values around the candidate location of at least one other channel of the image, wherein the at least one other channel is different from the first channel.

### BACKGROUND

Corner detection may be used to locate corners of a document that is contained in an image. Knowing the location of the corners allows the document to be registered, and the document extracted from the image. Extraction of a document from an image may find application in digital printing technologies, as well as other fields, such as image processing.

### BRIEF DESCRIPTION OF THE DRAWINGS

Examples are further described hereinafter with reference to the accompanying drawings, in which:

FIG. 1 illustrates an image in accordance with some examples.

FIG. 2a illustrates a method in accordance with some examples.

FIG. 2b illustrates a method to find the boundary of a document in accordance with some examples.

FIG. 3 illustrates a method to check a validity of a candidate location of a boundary in accordance with some examples.

FIG. 4 illustrates a method to check a validity of a candidate location of a boundary in accordance with some examples.

FIG. 5 illustrates a method to identify of a corner of a document in accordance with some examples.

FIG. 6 is a schematic of the method to improve the identification of a corner of a document in accordance with some examples.

FIG. 7a illustrates an apparatus to find a validity of a candidate location of a boundary in accordance with some examples.

FIG. 7b illustrates an apparatus to refine a corner location estimate in accordance with some examples.

FIG. 8 illustrates a system to find a validity of a candidate location of a boundary in accordance with some examples.

FIG. 9a illustrates a computer readable medium in accordance with some examples.

FIG. 9b illustrates a computer readable medium in accordance with some examples.

FIG. 10 illustrates a printing device 1000 according to some examples.

### DETAILED DESCRIPTION

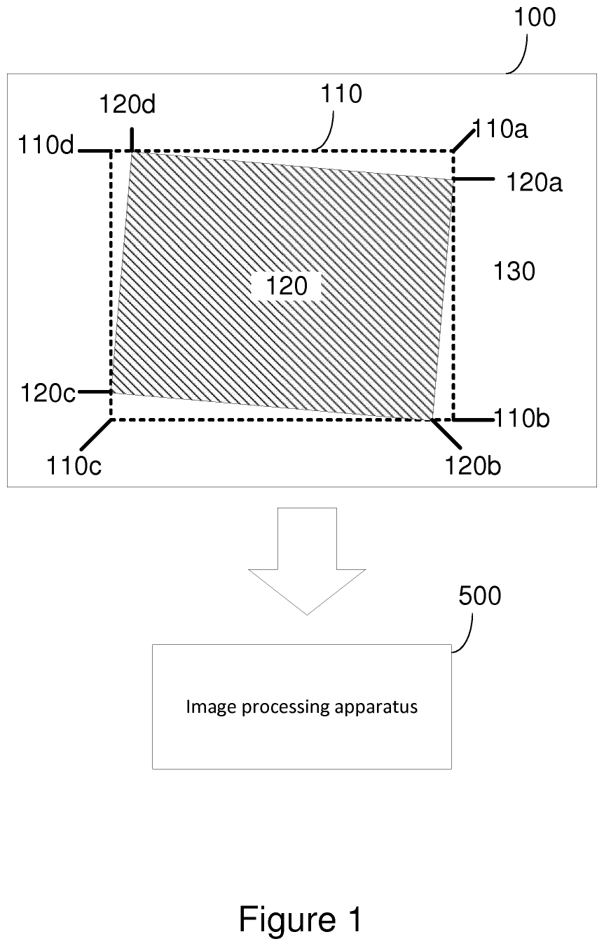

FIG. 1 illustrates an image 100. The image 100 may be captured by an image capture device (e.g. produced by an image scanner) and may be referred to herein as a captured image 100. In some examples the captured image 100 is produced by an inline scanner (e.g. of a printing apparatus, such as a digital printing press), however the image scanner may be any type of image scanning apparatus or other image capture apparatus, such as a digital camera. The captured image 100 may comprise a document 120 and a background area 130. When capturing an image of a document 120 the image scanning apparatus may also capture the surrounding area of the scanner backplate or surface the document 120 is placed on or against. This background surface may form the background area of the captured image. A user may wish to extract the document 120 from the captured image, or otherwise identify the document. The document 120 may correspond with the document page or similar that a user desires to extract from the captured image 100. The document 120 may be skewed relative to the captured image 100. In some examples, for example when using an inline scanner, a smaller skew may be expected that that shown in FIG. 1, which has been selected for illustrative purposes. In some examples, the document may be square or rectangular.

In some cases, detection of the document corners 120a-120d may be challenging if the contrast between the document corners 120a-120d and the background area 130 is low. This may be the case when the document 120 comprises a non-white substrate, or when the background area 130 and the document 120 have a similar color. Some examples may provide improved corner detection in such cases.

FIG. 1 also illustrates an image processing apparatus 700 to receive the captured image 100, and process (e.g. extract) the document 120 according to the examples herein.

According to some examples, the document 120 may be extracted by identifying locations of the document corners 120a-120d. A registration process may be performed on the captured image 100, such that the captured image 100 is translated and/or rotated into a coordinate system in which the document 120 is aligned with reference axes, based on the location of the document corners 120a-120d. In some examples the reference axes may be aligned with features of the image scanner, or the edges of the captured image prior to the registration. For example, following registration, one document corner 120c may be mapped to the origin of the reference axis (0,0), document corner 120b may be mapped to point (b,0) relative to the reference axis, document corner 110a may be mapped to point (b, a) relative to the reference axes, and document corner 120d may be mapped to point (0,a) relative to the reference axes.

Once the document 120 is registered it may be extracted from the page, in some examples this may be performed by cropping the captured image to obtain the document 120. Improving the accuracy of the location of the document corners 120a-120d may lead to an improvement in the registering of the document 120 and/or cropping of the captured image 100. The following examples describe techniques which may be used to find the location of the document corners 120a-120d. In some examples the document may be cropped prior to registration. In some examples, cropping and registering the document may be performed simultaneously (e.g. in a single transformation).

The captured image 100 may be represented as a plurality of pixels. The pixels may be arranged in a regular two-dimensional grid. Each pixel may have one or more corresponding values describing of the appearance of that pixel. For example, each of the one or more values of the pixel may indicate an intensity of a particular color, a luminance, a chrominance, lightness, etc. The captured image may be described by one or more channels. Each channel corresponds with a value associated with a pixel to describe the appearance of the pixel. For example, if the captured image is represented in a RGB color space, the image has a red channel, a green channel and a blue channel, and each pixel has a respective red value, green value and blue value representative of the intensity of the respective color (red, green or blue) in the pixel. Other color spaces could be used, such as CMYK (cyan, magenta, yellow and black channels), HSV (hue, saturation and value channels), HSL (hue, saturation and lightness/luminance channels), LAB (lightness, green-red and blue-yellow channels) etc.

A grayscale image is an image with a single channel; that is, an image in which each pixel has a single respective associated value. Each channel of an image having multiple channels can be viewed as a respective grayscale image. Herein, grayscaling refers to generating a grayscale image from an image having one or more channels. The result of grayscaling an input image is referred to herein as a grayscaled image. The grayscaled image may be considered to be an additional channel of the input image.

In some examples, the respective value of each pixel of a grayscaled image may correspond with a luminance of the corresponding pixel of the input image. The luminance may be, for example in an RGB color space, a weighted sum of the intensities of each color of a pixel. In some examples, the luminance of the captured image 100 may be defined as

L=a*R+b*G+c*B (1)

where L is the luminance, R, G, and B are the respective intensities of each channel of the color image, and a, b and c are weighting constants. The parameters a, b and c may be chosen such that L corresponds with physiological perceived colors in human color vision, for example a=0.30, b=0.59, and c=0.11 may be used. Luminance may be derived from other color spaces, either via a direct transformation or by converting to one or more intermediate color spaces.

The captured image 100 may be a color image, black and white image, or grayscale image. In some examples, each channel (e.g. a channel of an input image or a grayscaled image) may have 4 bits of information per pixel (e.g. 16 levels of intensity). In some examples, each channel may have 8 bits of information per pixel (e.g. 256 levels of intensity). In some examples, each channel may have 16 bits of information per pixel (e.g. 65,536 levels of intensity). Other numbers of bits of information per pixel may be used.

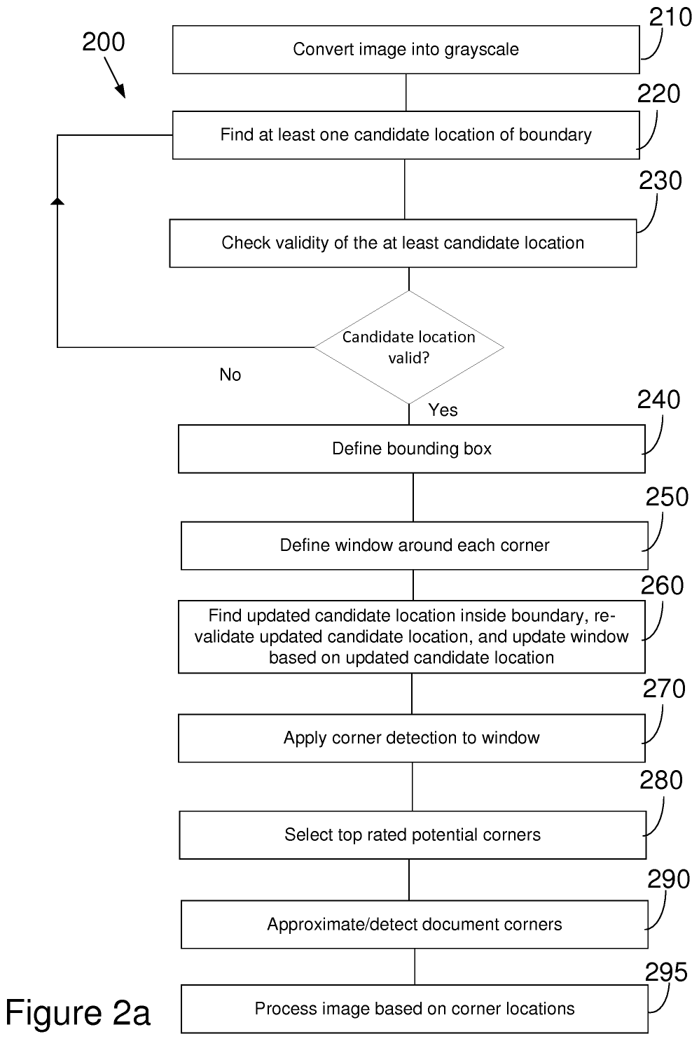

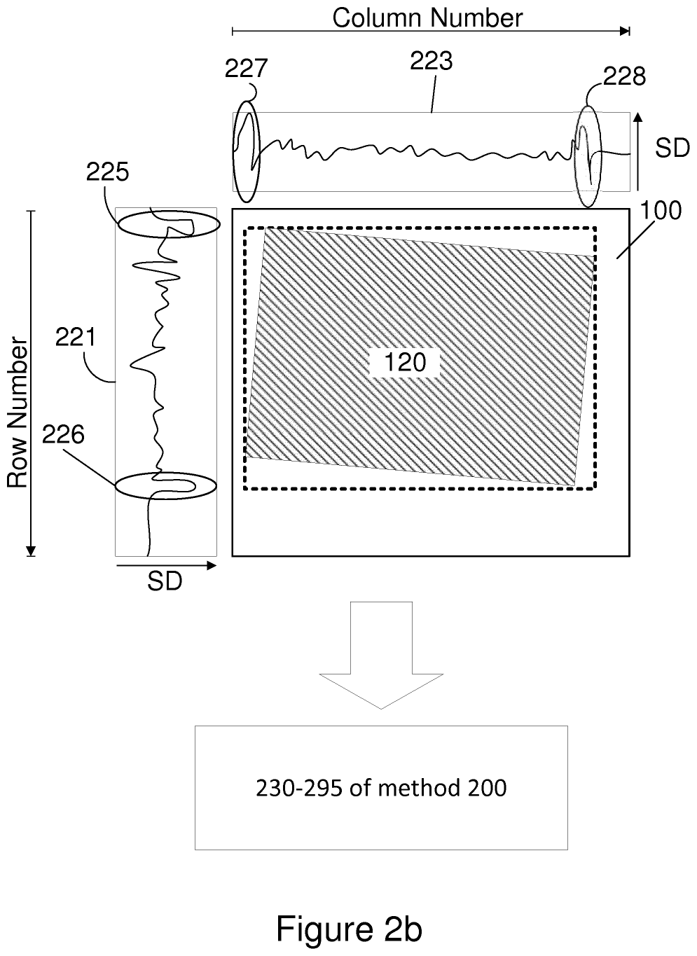

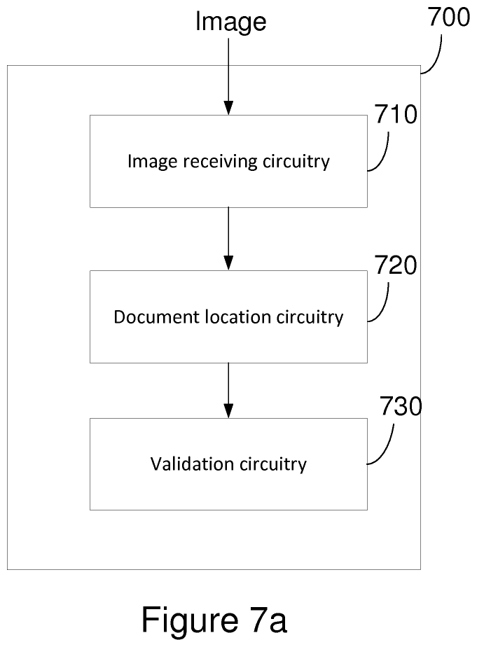

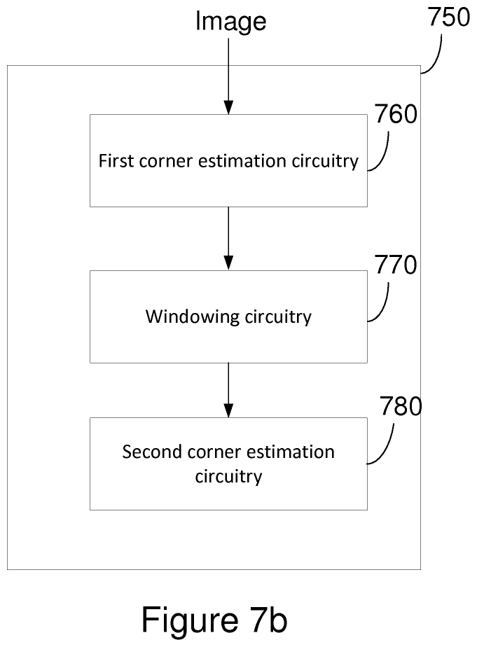

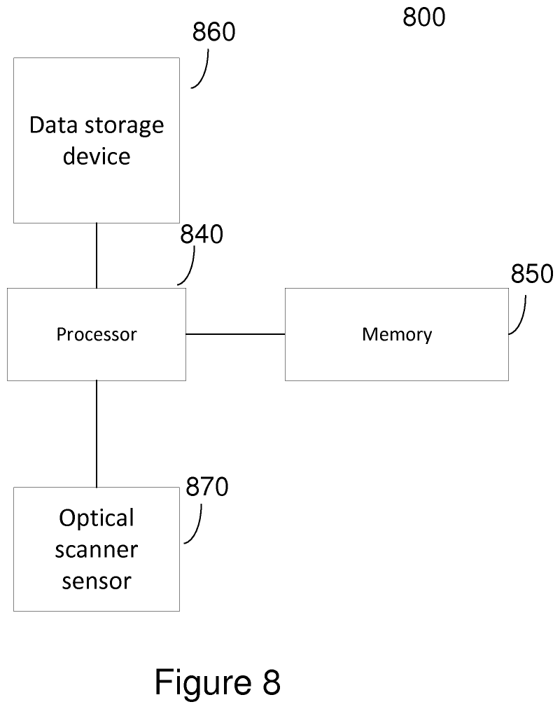

FIG. 2a illustrates a method 200 to identify the document corners 120a-120d of a document 120. The method 200 may be performed by image processing apparatus 700. A captured image 100 may be converted into a grayscaled image at 210. At least one candidate location of a boundary between the document and the background area may be found at 220. The boundary may be found based on the grayscaled image, which in some examples may reduce processing involved in finding the at least one candidate location. The validity of the at least one candidate location may be checked at 230 by a validation process. If the candidate location is determined to be valid, then the candidate location may be used to define a bounding box at 240, otherwise a new candidate location may be found. The bounding box provides an estimate of the document 120 location, and gives an approximate (or estimated) location for each of the document corners 120a-120d of the document 120. A window may be defined 250 at or around each corner of the bounding box 110a-110d. The operations at 220, 230, and 240 may be repeated at 260 for each of the windows to provide a refined window for each of the document corners 120a-120d, thus providing a refined approximation (or estimate) of the location of each of the document corners. An example method of refinement of the windows is described in relation to FIGS. 7 and 8.

A corner detection method may be applied within each of the refined windows at 270 to identify one or more potential corners in each window. In some examples, applying the corner detection within the windows may lead to a reduction in processing burden, compared with applying corner detection over the whole image. In some examples, applying the corner detection within the windows may lead to improved accuracy (e.g. fewer false positives) relative to applying corner detection across the whole image.

A selection may be made from among the identified potential corners at 280 to identify a reduced subset of the potential corners. A respective corner may be selected from each reduced subset, and designated a detected corner of the document. Accordingly, the location of each of the document corners 120a-120d may be approximated as a respective the location of the corresponding detected corner (being one of the potential corners of the corresponding reduced subset).

In some examples, the potential corner of the reduced subset having the shortest distance relative to the corresponding corner of the bounding box is selected as the detected corner. For example, the top left detected corner is the potential corner (of the reduced subset of the top left window) that is closest to the top left corner of the bounding box.

The scanned image may then be processed 295 in accordance with the detected document corners. For example, by showing the captured image 100 on a display with the location of the detected document corners marked or identified. In some examples, the processing 295 includes cropping and/or registering the document 120.

The conversion of the captured image 100 at 210 may be based on the conversion factor in equation (1). Alternatively, it may be based on another conversion factor. The captured image 100 may be converted into grayscale before or after being received by the image processing apparatus 700. In some examples the conversion may be based on a single channel of a color image, for example a green channel of an RGB image may be used. The human eye is more sensitive to green than red or blue, and so the green channel gives an approximation of luminance without requiring the processing to calculate the luminance according to equation (1).

Finding at least one candidate location of a boundary at 220 may be based on a standard deviation of a property of the pixels of each row and column of the captured image 100. In some examples, the property may be a luminance of, or derived from, the captured image (e.g. by grayscaling the image). This is described in more detail with reference to FIG. 2b. In some examples, the at least one candidate location is found based on an identification of first 225 and last 226 discontinuities in the standard deviation of the property of the rows of pixels 221 of the captured image 100. The candidate location may also be based on the first 227 and last 228 discontinuity in the standard deviation of the property of the columns of pixels 223 of the captured image 100. In some examples, discontinuities in the standard deviation of the property may be identified using an edge detection technique, for example a Canny edge detector. A discontinuity may be a sharp change in value of the standard deviation. The property may be a gray level, a luminance, or an intensity (such as an intensity of the green channel of an RGB image) although other image properties that exhibit a discontinuity at a document edge could be used.

In some examples, a standard deviation of the intensity of the rows of pixels may be calculated, such that each row has a corresponding standard deviation, being the standard deviation of the property values of the pixels in that row. The first and last discontinuities in the standard deviation of the rows of pixels may be identified as candidate locations of the boundary. Here, first and last may be with respect to a direction perpendicular to the rows. For example, if the rows are numbered consecutively, the first discontinuity may correspond with the lowest numbered row that corresponds with a discontinuity in the standard deviation.

Similarly, the last discontinuity may correspond with the highest numbered row that corresponds with a discontinuity. Discontinuities may be detected using a Canny edge detector. For example, the Canny edge detector may be applied to a graph of standard deviation of the property (SD) against row number. In some examples, location in a column direction may be used in place of row number. The first and last discontinuities may determine position, along the column direction, of the candidate locations.

In some examples, a standard deviation of the intensity of the columns of pixels may be calculated, and the first and last discontinuities in the standard deviation of the columns of pixels may be identified using a Canny edge detector. The first and last discontinuities of both the rows and columns may identify the candidate locations. The candidate locations may define the boundaries at or between intersections between the rows and columns having the first and last discontinuities. That is, if rows a and b have the first and last discontinuities, respectively, and columns c and d have the first and last discontinuities, respectively, the edges between (c,a) and (d,a), (d,a) and (d,b), (d,b) and (c,b), and (c,b) and (c,a) may be identified as candidate boundaries.

In some examples the validity of the candidate location may be checked at 230. In some examples this may be based on pixel values a first channel of the captured image 100 around the candidate location, and pixel values of at least one other channel of the captured image 100 around the candidate location, wherein the first channel is different from the at least one other channel.

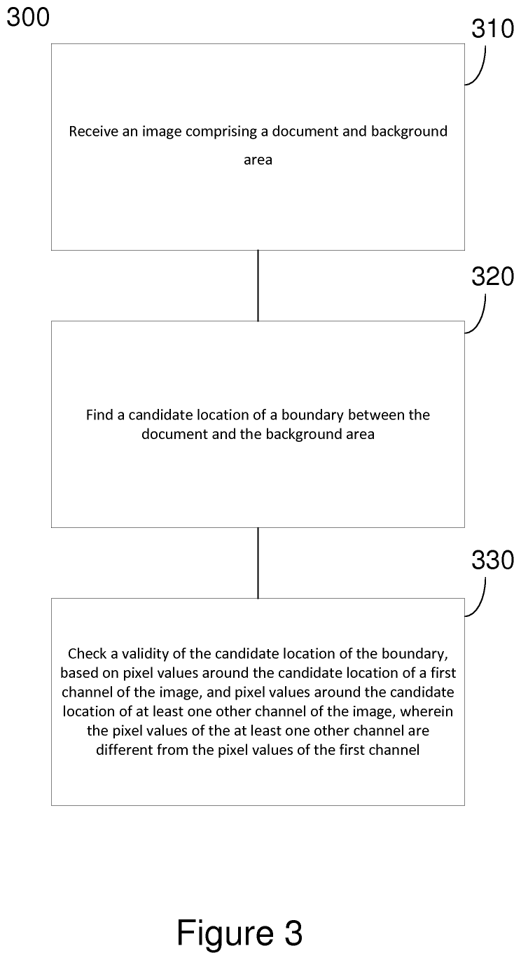

An example of the method to check the validity at 230 is described in in more detail below in relation to FIG. 3.

The bounding box 110 may be defined at 240 based on the candidate locations. The bounding box corners 110a-110d of the bounding box 110 may not be in the same location as the document corners 120a-120d, for example if the document 110 is skewed relative to the background area 130.

A window may be defined around each boundary location or corner. In some examples, the size of the window may be a percentage of the size of the captured image 100. In some examples, the window may be a constant size (e.g. a predetermined number of pixels). In some examples the window may have the same aspect ratio as the captured image 100, or in some examples the window may have a different aspect ratio. The window may be square, or rectangular. In some examples the window may be circular or oval. In some examples the window may have an area of 10 pixels by 10 pixels. In some examples the window may have an area of x*y pixels where x is less than the width of the captured image 100 in pixels and y is less than the height of the captured image 100 in pixels. In some examples the window may contain or be centered on the candidate location. In some examples a corner of the window may be aligned with a boundary of the document 120, such that the corners of the boundary and window coincide. In some examples, respective windows may be defined for each candidate location. In some examples a corner of each window may be aligned to a corner of the bounding box 110 such that each window is substantially inside the bounding box 110.

The bounding box corners 110a-110d may be refined at 260 by a refinement process. An example of this process is described in more detail below, with reference to FIGS. 7 and 8. The refinement process may comprise finding an updated candidate location, validating the updated candidate location, and updating the window based on the updated candidate location. This process of refinement may be performed a set number of times, or alternatively may be performed until a predetermined criterion is met. In some examples the criterion may include the updated candidate location and previous candidate location being within a certain distance (e.g. a user-specified limit) of each other.

Corner detection may be applied within each window at 270 to identify a plurality of potential document corners in each window. In some examples the corner detection may comprise applying a Harris corner detector. Other corner detection methods may be used, such as a SUSAN corner detector or a minimum eigenvalue detector. Corner detection may result in a plurality of potential document corners identified inside the window. A document corner 120a-120d may be identified based on a comparison of the candidate location and the positions of the plurality of potential corners. Each potential corner may have an associated strength assigned by the corner detection method. For example, a Harris corner detector associates a value of R with each potential corner that it detects, as described below.

A Harris corner detector assumes a change in intensity E(u,v) for a shift [u,v] is defined by

$$E ( u , v ) = {\sum }_{x , y} {w ( x , y ) [ I ( x + u , y + v ) - I ( x , y ) ]}^{2} \qquad ( 2 )$$

Where w(x,y) is a window function, I(x+u, y+v) is the shifted intensity, and I(x,y) is the non-shifted intensity. The window defined by the window function for the purposes of the Harris corner detection does not correspond with the window used in operation 250 or 260. Herein, the window defined by the window function will be referred to as a Harris window, to distinguish these different windows. The window function may be defined as 1 inside the Harris window, and 0 outside, or alternatively may be a Gaussian window. Other window functions may also be used. For Harris windows that contain no boundaries, I(x+u, y+v)−I(x,y) will be small. However, if there is a boundary in the Harris window then I(x+u, y+v)−I(x,y) will be large.

Therefore a Taylor expansion may be used, to obtain

Σ[I(x+u,y+v)−I(x,y(²]≈Σ[u²Iₓ²+2uvIₓI_{y}+v^{w}I_{y}²] (3)

where Iₓ and I_{y} are the partial derivatives of I in the x and y directions. Therefore E(u,v) may be rewritten in matrix form as

$$( \sum [ \begin{matrix}{I}_{x}^{2} & {I}_{x} {I}_{y} \\ {I}_{x} {I}_{y} & {I}_{y}^{2}\end{matrix} ] ) [ \begin{matrix}u \\ v\end{matrix} ] \qquad ( 4 )$$

And for small shifts [u,v] a bilinear approximation may be used to define

$$E ( u , v ) ≅ [ u , v ] M [ \begin{matrix}u \\ v\end{matrix} ] \qquad ( 5 )$$

Where

$$M = \sum w ( x , y ) [ \begin{matrix}{I}_{x}^{2} & {I}_{x} {I}_{y} \\ {I}_{x} {I}_{y} & {I}_{y}^{2}\end{matrix} ] \qquad ( 6 )$$

Iₓ and I_{y} may then be plotted against each other for each point inside the Harris window to obtain a scatter plot. An ellipse covering the points of radii λ₁ and λ₂ may then be calculated. If λ₁ and λ₂ are small and approximately equal then there is likely no corner or boundary inside the Harris window. If λ₁ and λ₂ are large and approximately equal then there is likely a corner inside the Harris window. If λ₁ is large and λ₂ is small (or vice versa), then there is likely a boundary inside the Harris window.

The strength of the corner may be defined as R, where R=det M−k(trace M)² where k is an empirically determined constant in the range of 0.04 to 0.06. It is noted that det M=λ₁ λ₂ and trace M=λ₁+λ₂.

The top-rated corners (e.g. the corners identified as strongest, having the highest values of R) may be selected at 280 from the potential corners to obtain a subset of potential corner locations. In some examples this may comprise selecting n potential corner locations with the highest strength, where n is any integer. In some examples n may be 5, 10 or 20.

The detected corner locations may be set at 290. In some examples, the corner locations may be identified as the potential corner location, among the subset of potential corner locations, inside the window that is closest to the corresponding bounding box 110 corner. For example, the upper right document corner 120a may be identified based on a potential corner location (of the subset of potential corner locations) that is closest to the upper right bounding box corner 110a; the lower right bounding box corner 110b may be identified based on the potential corner location that is closest to the lower right bounding box corner 110b; the lower left bounding box corner 110c may be identified based on the potential corner location that is closest to the lower left bounding box corner 110c; the upper left document corner 120d may be identified based on a potential corner location that is closest to the upper left bounding box corner 110d.

In some examples the corner location may be set as the potential corner location, among the subset of potential corner locations, that is closest to the corresponding bounding box corner 110.

In some examples a corner location may be selected from potential corner locations by first selecting a subset that are closest to the corresponding corner of the window, and then selecting a corner among the subset that has a highest strength value. In some examples a metric may be determined combining, for example, distance from the corresponding corner of the window and a strength value. The metric may be a linear combination or in some other combination of factors to be used in selecting a single corner from the plurality of potential corner locations.

In some examples the window corners may have a different location from the document corners 120a-120d. For example, due to a skew of the document.

At 295, processing may be carried out on the image, based on the locations of the detected corners. For example, the location of the document corners 120a-120d may be marked or indicated on a display of the captured image. In some examples the location of the document corners may be stored. In some examples, processing 295 may include registering and/or cropping the captured image.

An example method 300 for validating a candidate location of a boundary between a document 120 and the background area 130 is described in accordance with FIG. 3. The method 300 may be used to validate a location of a boundary. The method 300 may be used in operation 230 of FIG. 2a. In some examples, the method 300 may be used in other applications or used independently.

The captured image 100 may be received at 310. The captured image 100 may include a document 120 and a background 130. A candidate location of a boundary between the document 120 and the background 130 may be found or received at 320. The validity of the candidate location may be determined at 330.

In some examples, at least one candidate location may be found at 320. In some examples this may be found by calculating the standard deviation of each row and column of the captured image 100, and finding the first and last discontinuities in the standard deviation of the rows and columns. In some examples finding the first and last discontinuities of the rows and columns may be performed using edge detection, for example a Canny edge detector. This may correspond with the candidate boundary location at 220 in the method of FIG. 2a.

In some examples, the boundary may be an edge or a corner. In some examples a bounding box 110 may be defined based on at least one candidate location. The bounding box 110 may provide an estimate of the area occupied by the document 120. In some examples, the bounding box 110 may be defined based on at least four candidate locations 110a-110d, each candidate location being an estimate of the location of a document corner 120a-120d of the document 120.

In some examples the validity of the candidate location may be determined at 330 based on pixel values, around the candidate locations, of a first channel of the captured image 100, and pixel values of at least one other channel of the captured image 100, wherein the first channel is different from the at least one other channel. Carrying out the validation using a first channel and at least one other channel may lead to a more robust or accurate validation. The at least one other channel may have different information content compared with the first channel, such that the validation operation may make use of more of the information available in the captured image. In some examples, this additional use of information in the captured image does not significantly increase processing requirements.

In some examples, one or more of the first channel and at least one other channel are channels of the captured image. In some examples, one or more of the first channel and at least one other channel are not channels of the captured image and are derived from the captured image prior to receiving the image at operation 310, and are received prior to operation 330. In some examples, one or more of the first channel and at least one other channel are not channels of the captured image and are determined as part of method 300, prior to operation 330.

In some examples the first channel is obtained by grayscaling the captured image. In some examples the first channel is a luminance channel. In some examples the at least one other channel includes one or more of a red channel, a green channel and a blue channel. In some examples the at least one other channel includes all of a red channel, a green channel and a blue channel.

In some examples, the validity of the candidate location may be determined at 330 based on a determination of a first statistic of the pixel values around the candidate location of the first channel, and a comparison between the first statistic and a background statistic associated with the background area, wherein the background area 130 is the area outside the document 130 (or, in some examples, the area outside the document assuming that the candidate location of the boundary is a boundary of the document).

In some examples, the first statistic in an indication of variation in the pixel values of the first channel across the candidate boundary. In some examples, the background statistic is an indication of variation in the pixel values (e.g. of the first channel) across the background. In some examples, where the variation across the candidate boundary is determined to be less than the variation of the background, it may be determined that the candidate boundary is not a valid boundary.

In some examples the first statistic is an average (1D, one-dimensional) standard deviation of pixel values in the first channel around the candidate location. For example, if the candidate location is a candidate edge that is approximately vertical (e.g. crossing more rows than columns per unit length of the edge) the standard deviation may be calculated for each row, based on a set of pixels around the candidate edge (e.g. 10 pixels either side of the candidate edge). The average (e.g. mean) value of the standard deviations associated with than candidate edge may then be calculated as the first statistic. Herein, this mean of the 1D standard deviation of pixel values around the candidate edge is referred to as stdmean.

In some examples an upper bound (TH) and a lower bound (TL) are defined based on the background statistic. The background statistic may be the standard deviation of pixel values corresponding the background area 130. In some examples, upper and lower thresholds/bounds may be determined for a horizontal direction, to give THₕ and TLₕ (high and low thresholds/bounds in the horizontal direction). Similarly, upper and lower thresholds/bounds may be determined for a vertical direction, to give THᵥ and TLᵥ (high and low thresholds/bounds in the vertical direction). The horizontal bounds may be used when validating horizontal candidate boundaries, and the vertical bounds may be used when validating vertical candidate boundaries.

In some examples, the horizontal upper bound is the highest standard deviation among 1D standard deviations of pixel values in columns of background pixels. That is, the 1D standard deviation is determined for each column of a plurality of columns of background pixels, and the upper bound is the highest of these standard deviations. Similarly, the horizontal lower bound is the lowest standard deviation among 1D standard deviations of pixel values in columns of background pixels. Similarly, the vertical upper bound is the highest standard deviation among 1D standard deviations of pixel values in rows of background pixels and the vertical lower bound is the lowest standard deviation among 1D standard deviations of pixel values in rows of background pixels. In some examples, the background statistic is based on pixel values of a single channel. In some examples, the single channel is the same as the first channel. In some examples, the single channel is a luminance channel. In some examples, the background statistic may be calculated based on an image of the background without the document (e.g. an image of the background captured before the captured image including the document).

In some examples the candidate location is determined to be not valid if the first statistic is within the range between a lower bound, TL, and the upper bound, TH. For example, the candidate location is determined to be not validated if TL≤stdmean≤TH.

In some examples the background statistic may be previously determined for a particular background (e.g. a particular scanner backplate). Accordingly, in some examples the background statistic is not calculated for each captured image. In some examples, the background statistic may be calculated based on the background area of the captured image 100, and may be calculated for each successive captured image.

In some examples, the validation may be based on at least one other statistic. In some examples, the validity of the candidate location may be based on a comparison of the at least one other statistic to at least one other (or further) background statistic associated with the background area. In some examples, the validation may be based on a difference between a value of the at least one other statistic and a value of the at least one other background statistic. The difference may be indicative of a difference between image properties (e.g. color) before and after the boundary.

In some examples, the at least one other statistic may be based on a median of pixel values around the candidate location. In some examples the at least one other channel is different from the first channel. For example, if the first channel is a grayscaled channel, the at least one other channel may be one or more channels other than the grayscaled channel.

In some examples the at least one other channel may be a red channel, a green channel and a blue channel. captured image 100 may be a RGB image, comprising a red channel, a green channel and a blue channel.

The at least one other statistic may include respective median values for each of the red, green and blue channels. For example, a median of the pixel values in the red color channel in a region of the candidate boundary on the document side of the candidate boundary may be determined, and referred to herein as median_r(doc). The region of the candidate boundary, over which the median is determined, may be, for example, a region within the bounding box and within a predetermined number of pixels of the candidate boundary. For example, if the candidate boundary is a vertical edge, for each row of pixels containing the edge, the region may be 10 pixels of that row that are within the bounding box and closest to the vertical edge. Other numbers of pixels may be used to define the region. For example, the region may be 5 pixels from the edge, 20 pixels from the edge, etc.

Similarly, median document values in the region of the candidate boundary may be determined for the green and blue channels, to give median_g(doc) and median_b(doc), respectively. In some examples the median may be calculated for channels other than red, green and blue channels.

In some examples the at least one other background statistic may include respective median values for each of the red, green and blue channels (or other channels corresponding with the channels used to determine the at least one other statistic). For example, a median of the pixel values in the red color channel in a region of the candidate boundary on the background side of the candidate boundary may be determined, and referred to herein as median_r(bg). The region of the candidate boundary, over which the median is determined, may be, for example, a region along the candidate boundary and outside the bounding box, within a predetermined number of pixels of the candidate boundary. For example, if the candidate boundary is a vertical edge, for each row of pixels containing the edge, the region may be 10 pixels of that row that are outside the bounding box and closest to the vertical edge. Other numbers of pixels may be used to define the region. For example, the region may be 5 pixels from the edge, 20 pixels from the edge, etc.

Similarly, median background values in the region of the candidate boundary may be determined for the green and blue channels, to give median_g(bg) and median_b(bg), respectively. In some examples the median may be calculated for channels other than red, green and blue channels.

A difference between the at least one other statistic and the at least one other background statistic may be evaluated. For example, diff_median_r may be evaluated as |median_r(doc)-median_r(bg)|. Similarly, diff_median_g=|median_g(doc)-median_g(bg)| and diff_median_b=|median_b(doc)-median_b(bg)|.

In some examples the candidate location may be determined to be not valid if diff_median_r≤TH_color, and if diff_median_g≤TH_color, and if diff_median_b≤TH_color, where TH_color is a color contrast threshold. TH_color may be determined prior to performing the method. TH_color may be empirically found by, e.g. by a user or a device manufacturer. TH_color may be different for each color (or channel).

In some examples the validity of the candidate location may be determined 330 based on both the determination of the first statistic of the pixel values around the candidate location of the first channel and the determination of the at least one other statistic of the pixel values around the candidate location of the at least one other channel. In some examples, the candidate location may be determined to be valid upon meeting the criteria of:

(stdmean<TL or stdmean>TH); and 1.

(diff_median_r>TH_color) or (diff_median_g>TH_color) or (diff_median_b>TH_color) 2.

In some examples, one or more of the relational operators (less than, greater than) above may be replaced with the corresponding operator that allows for equality (less than or equal to, greater than or equal to). Other arrangements are possible for determining validity of a candidate location based on the first statistic, background statistic, at least one other statistic and at least one other background statistic.

In some examples, a new candidate location of the boundary may be found if the candidate location is determined to be invalid. This may comprise finding the next discontinuities of each row and column. In some examples a next discontinuity may be the next detected discontinuity along the same axis as the invalidated discontinuity in a direction that reduces the size of the bounding box. For example, if the discontinuity 225 of FIG. 2a (i.e. the first discontinuity along the vertical direction) is found to be invalid, the next discontinuity is the next discontinuity that is arrived at moving down the page from the first discontinuity 225. The process may be repeated until a candidate boundary is found that satisfies the above requirements.

In some examples the candidate location may be one of a plurality of candidate locations, and validating the candidate location may further comprise finding the plurality of candidate locations, and determining the validity of each of the plurality of the candidate locations, wherein the plurality of candidate locations 110a-110d define a bounding box 110 around the document.

In some examples, the first statistic and the background statistic may be based on one or more of smoothness, uniformity, entropy, gray level co-occurrence matrix, invariant moments, or spectral texture measures. In some examples, these may produce reliable results when the background has a 2D (two-dimensional) texture.

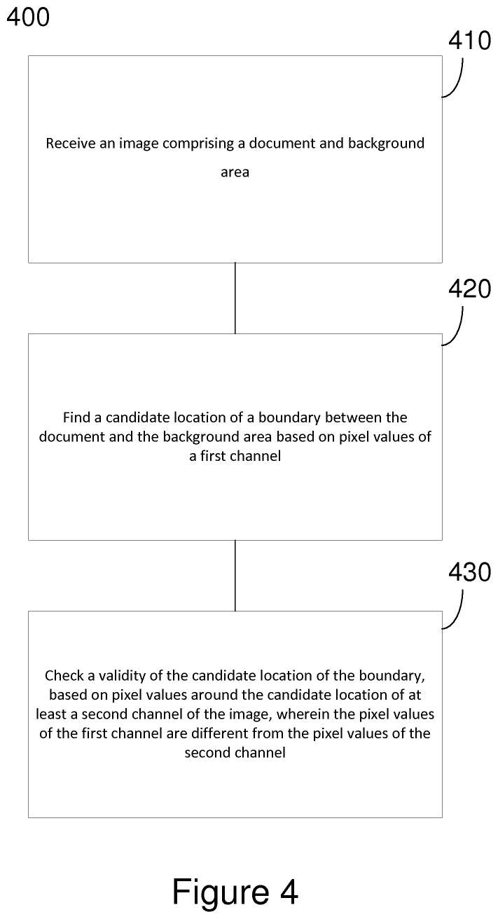

An example method 400 for validating a candidate location of a boundary between a document 120 and the background area 130 is described in accordance with FIG. 4. The method 400 may be used in operation 230 of FIG. 2a. In some examples, the method 400 may be used in other applications or used independently.

The captured image 100 may be received at 410. The captured image 100 may include a document 120 and a background 130. A candidate location of a boundary between the document 120 and the background 130 may be determined 420 based on pixel values of a first channel of the captured image 100. The validity of the candidate location may be determined at 430, based on based on pixel values around the candidate location of at least a second channel of the image, wherein the first channel is different from the second channel.

In some examples, at least one candidate location may be found at 420. In some examples this may be found by calculating the standard deviation of each row and column of a first channel of the captured image 100, and finding the first and last discontinuities in the standard deviation of the rows and columns. In some examples finding the first and last discontinuities of the rows and columns may be performed using edge detection, for example a Canny edge detector. This may correspond with the candidate boundary location at 220 in the method of FIG. 2a.

In some examples the first channel is a luminance channel. In some examples, the first channel is derived from the captured imaged by grayscaling the captured image.

In some examples, the boundary may be an edge or a corner. In some examples a bounding box 110 may be defined based on at least one candidate location. The bounding box 110 may provide an estimate of the area occupied by the document 120. In some examples, the bounding box 110 may be defined based on at least four candidate locations 110a-110d, each candidate location being an estimate of the location of a document corner 120a-120d of the document 120.

In some examples the validity of the candidate location may be determined at 430 based on pixel values, around the candidate locations, of a second channel of the captured image 100, wherein the first channel is different from the second channel. Carrying out the validation using at least a different channel from the channel used to detect the candidate location may lead to improved accuracy. For example, using different channels may make use of more of the information contained in the captured image, and may lead to improved independence between the detection and validation of the candidate location. In some examples, the additional use of information in the captured image does not significantly increase processing requirements.

In some examples, the validity of the candidate location may be determined 430 based on a determination a first statistical measure of the pixel values around the candidate location of the first channel, and a comparison of the first statistical measure to a statistical measure associated with the background area.

In some examples, a plurality of second channels, each different from the first channel, may be used to determine the validity of the candidate location.

In some examples, the first channel and/or the second channel are channels of the captured image. In some examples, the first channel and/or the second channel are not channels of the captured image and are derived from the captured image prior to receiving the image at operation 410, and are received prior to operation 430. In some examples, the first channel and/or the second channel are not channels of the captured image and are determined as part of method 400, prior to operation 430.

In some examples the first channel is obtained by grayscaling the captured image. In some examples the first channel is a luminance channel. In some examples the second channel is a red channel, a green channel ora blue channel. In some examples, there are three second channels, a red channel, a green channel or a blue channel, respectively.

In some examples, the validity of the candidate location may be determined based on a statistical measure. The statistical measure may be similar to the at least one other statistic of the method 300.

In some examples the candidate location may be determined to be not valid if diff_median_r≤TH_color, and if diff_median_g≤TH_color, and if diff_median_b≤TH_color, where TH_color is a color contrast threshold, where diff_median_r, diff_median_g, diff_median_b and TH color are as described in relation to the method 300.

Further, in some examples the candidate location may be determined to be valid upon meeting the criteria of:

(stdmean<TL or stdmean>TH); and 1.

(diff_median_r>TH_color) or (diff_median_g>TH_color) or (diff_median_b>TH_color), 2.

Where stdmean, TL and TH are as described above in relation to method 300.

In some examples, stdmean, TL and TH are determined based on a single channel, and the single channel is the first channel (i.e. the channel used in operation 420).

In some examples, one or more of the relational operators (less than, greater than) above may be replaced with the corresponding operator that allows for equality (less than or equal to, greater than or equal to).

In some examples, a new candidate location of the boundary may be found if the candidate location is determined to be invalid. This may comprise finding the next discontinuities of each row and column. The validation may then be performed on the new candidate location.

In some examples the candidate location may be one of a plurality of candidate locations, and validating the candidate location may further comprise finding the plurality of candidate locations, and determining the validity of each of the plurality of the candidate locations, wherein the plurality of candidate locations 110a-110d define a bounding box 110 around the document.

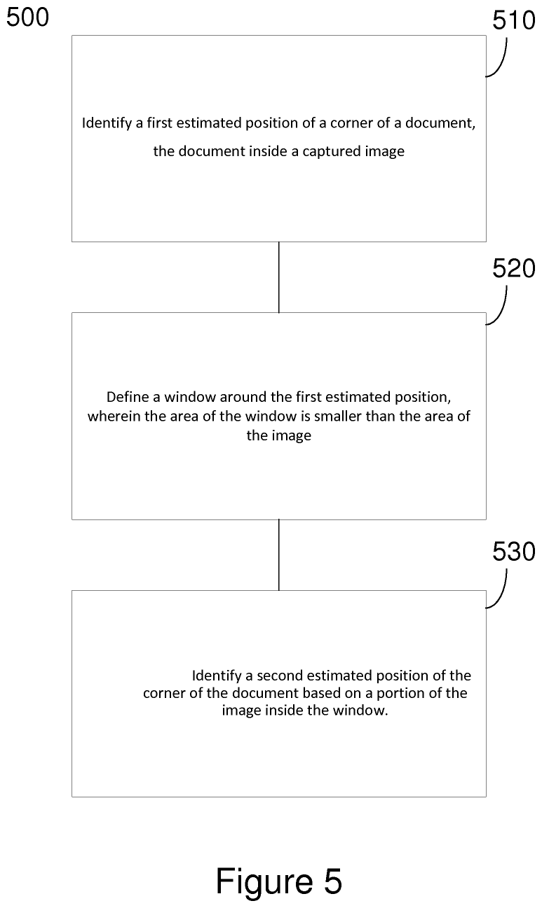

FIG. 5 illustrates an example method 500 to refine an estimate of a positon of a document corner 120a-120d of a document 120 according to some examples. The method 500 may be practiced as a part of method 200 (e.g. in operation 260), or independently from method 200.

Method 500 may be applied to an image, such as a captured image 100 of a document 120 and a background 130. The document is inside a captured image 100, and is smaller than the captured image 100. The background 130 may correspond to the portion of the captured image 100 that is not the document 120.

At 510 a first estimated position of a corner 120a-120d of a document 120 is identified. This may be carried out as described above in relation to operations 220 to 240 of method 200, for example.

At 520 a window is defined around the first estimated position, wherein the area of the window is smaller than the area of the image. In some examples, this may be carried out as described in relation to operation 250 of method 200.

At 530, a second estimated position of the corner 120a-120d of the document 120 based on a portion of the image inside the window is identified. In some examples, this may correspond with operation 260 of method 200.

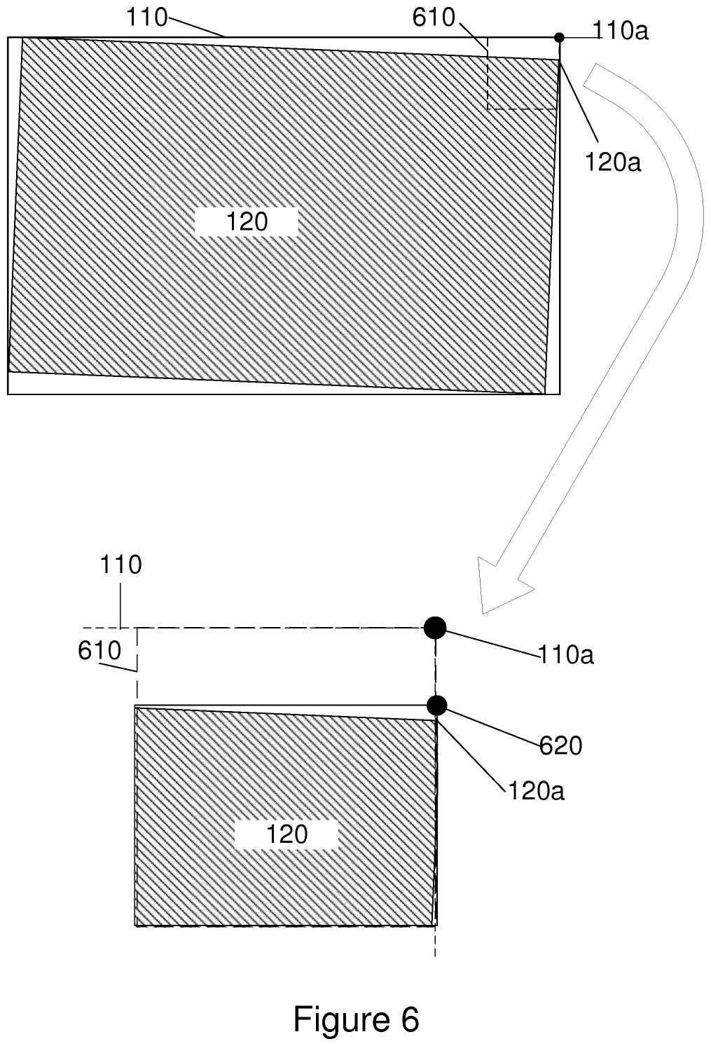

An example of the method 500 is described in more detail with reference to FIG. 6. In some examples a bounding box is defined around document 120, the bounding box may identify a first estimated position of the document corner 120a. in some examples the first estimated position may coincide with the bounding box corner 110a.

The first estimate may be identified based on at least one discontinuity in a statistical measure of pixel values of a plurality of rows and columns of the image. In some examples the statistical measure may be a 1D standard deviation of a channel of (or derived from) the captured image 100. In some examples, the channel is a luminance channel.

At 520 a window 610 is defined at or around the first estimated position. The corner of the window 610 may be aligned with the corner of the bounding box 110 such that the window is entirely inside the bounding box 110. In some examples, the window 610 may extend outside of the bounding box 110, such that the corner of the bounding box 110 is within the window 610. The window 610 may have an area smaller than the bounding box 110. The window 610 may have a square or rectangular shape.

At 530 a second estimated position 620 of the corner 120a of the document 120 may be determined based on a portion of the captured image 100 inside the window 610. In some examples the second estimated position 620 is identified based on at least one discontinuity in a statistical measure of pixel values. In some examples, the pixel values include pixel values (e.g. an intensity of pixels) in a channel of the captured image. In some examples, the channel is a luminance channel. The statistical measure may be a 1D standard deviation along rows and/or columns. For example, a 1D standard deviation may be calculated for each row inside the window, and a discontinuity in the standard deviation may be detected. Similarly, a 1D standard deviation may be calculated for each column inside the window, and a discontinuity in the standard deviation may be detected.

In the refinement process of some examples, each window may include a single corner 120 of the document 110, such that a single discontinuity in the standard deviation is to be found for the rows, and a single discontinuity in the standard deviation is to be found for columns within each window. Where multiple discontinuities are detected, a discontinuity may be selected as the second estimated position 620. The second estimated position 620 may be based on the discontinuity closest to the corner of the window corresponding to the bounding box corner that is being refined (or the corner of the document that is being approximated). For example, if the window is at (i.e. approximating) the top right corner of the document, such that the top right bounding box corner is being refined, the rightmost discontinuity may be selected in the horizontal direction and topmost discontinuity may be selected in the vertical direction.

As shown in FIG. 6, by performing a second refinement of the estimated position of the corner 120a of the document 120 inside the window an improved accuracy may be obtained for the estimate of the corner location.

In some examples, further processing may be carried out within the refined window to identify the document of the corner more accurately. In some examples a corner detection method may be applied inside refined the window. For example, a corner detection method may be applied as described in relation to operation 270 of method 200. In some examples, refining the window/estimated position may lead to a reduced window size/area. This may reduce a processing load associated with performing a corner detection method in the window.

In some examples the location of the corner of the document 120 may be estimated based on a comparison of the second estimated position 620 and possible corner locations identified by the corner detection method. In some examples the possible corner locations in the window identified by the corner detection method may be a subset of corner locations initially identified in the window by the corner detection method. For example, a strength value associated with corners detected by the corner detection method may be used to obtain the subset of corner locations.

In some examples the corner detection method is based on a determination of at least a partial derivative of the intensity of pixels inside the window. In some examples the corner detection method is based on at least one of a Harris corner detector, a SUSAN corner detector, and a minimum eigenvalue corner detector.

In some examples determining the first subset of possible corner locations comprises: determining a strength of each possible corner location and selecting the first subset based on the strength.

In some examples approximating the location of the corner of the page comprises comparing the distance from each of the first subset of possible corner locations to the second estimate 620 the location of the corner 120a.

An image processing apparatus 700 according to some examples is described in relation to FIG. 7a. The apparatus 700 comprises image receiving circuitry 710, document location circuitry 720, and validation circuitry 730.

The image receiving circuitry 710 is configured to receive an image. The image may be a captured image, and may include a document and a background.

The document location circuitry 720 is configured to to find a candidate location of a boundary between the document and the background based on pixel values of a first channel of the image. The document location circuitry 720 may be arranged to operate as described above in relation to operation 220 of FIG. 2a, operation 320 of FIG. 3 or operation 420 of FIG. 4.

The validation circuitry 730 is configured to validate the candidate location of the boundary, as described above in relation to operation 230 of FIG. 2, operation 330 of FIG. 3 or operation 430 of FIG. 4.

An image processing apparatus 750 according to some examples is described in relation to FIG. 7b. The apparatus 750 comprises first corner estimation circuitry 760, windowing circuitry 770, and second corner estimation circuitry 780.

The first corner estimation circuitry 760 is configured to receive an image. The image may be a captured image, and may include a document and a background. The first corner estimation circuitry 760 is arranged to determine a first estimated a position a corner of the document in the image. The first corner estimation circuitry 760 may be arranged to operate as described above in relation to operation 240 of FIG. 2a or operation 510 of FIG. 5.

The windowing circuitry 770 is configured to define a window around the first estimated position, with the area of the window being smaller than the area of the image. The windowing circuitry 770 may be arranged to operate as described above in relation to operation 250 of FIG. 2a or operation 520 of FIG. 5.

The second corner estimation circuitry 780 is arranged to identify a second estimated position of the corner of the document based on a portion of the image inside the window. The second corner estimation circuitry 780 may be arranged to operate as described above in relation to operation 260 of FIG. 2a or operation 530 of FIG. 5.

FIG. 8 is a schematic drawing of an example of a system 800 to automatically detect corners of an image of a captured image 100.

System 800 may include a processor 840. Processor 840 may include one or more intercommunicating processors that may operate in accordance with programmed instructions. For example, at least a component of processor 840 may be incorporated into a processor of a computer or into a processor or controller of an image scanner. All such processors and controllers are considered as incorporated into processor 840.

Processor 840 may communicate with memory 850. Memory 850 may include one or more volatile or non-volatile memory devices capable of storing data. For example, memory 850 may be utilized to store, among other data, programmed instructions to operate processor 840, acquired scanned images, results generated during or as a result of processing scanned images, or parameters or data utilized in processing scanned images.

Processor 840 may communicate with a data storage device 860. Data storage device 860 may represent a computer readable medium in the form of one or more fixed or removable non-volatile data storage devices. For example, data storage device 860 may be utilized to store, among other data, programmed instructions to operate processor 840, acquired scanned images, results generated during or as a result of processing scanned images, or processing scanned images.

Processor 840 may communicate with an imaging device represented by optical scanner sensor 870. Optical scanner sensor 870 may include a sensor, or a collection or array of sensors, such as a camera or scanner head, that are capable of acquiring a digital image of a document 120, or other object. For example, processor 840 may control scanner sensor 870 to acquire a captured image 100, the captured image including a document 120 and a background 130. The image may be in the form of an array (e.g. rows and columns) of pixels, each pixel including image data (e.g. polychromatic RGB data). Processor 840 may process the acquired image or store the acquired image in memory 850 or data storage device 860.

For example, processor 840 may control scanner sensor 870 to acquire an image of document 120. Document 120 may be scanned when placed on or held to the surface of the optical scanner sensor 870. For example, the surface may be a conveyer belt or other transport device for transporting document 120 to or past scanner sensor 870. For example, operation of a conveyance device represented the surface may be controllable by processor 840.

In some examples, the processer 840 may be arranged to operate as the image receiving circuitry 710, document location circuitry 720 and validation circuitry 730 of FIG. 7a. For example, memory 850 and/or data storage device 860 may include program instructions that, when executed, cause the processor to operate as the image receiving circuitry 710, document location circuitry 720 and validation circuitry 730 of FIG. 7a.

In some examples, the processer 840 may be arranged to operate as the first corner estimation circuitry 760, windowing circuitry 770, and second corner estimation circuitry 780 of FIG. 7b. For example, memory 850 and/or data storage device 860 may include program instructions that, when executed, cause the processor to operate as the first corner estimation circuitry 760, windowing circuitry 770, and second corner estimation circuitry 780 of FIG. 7b.

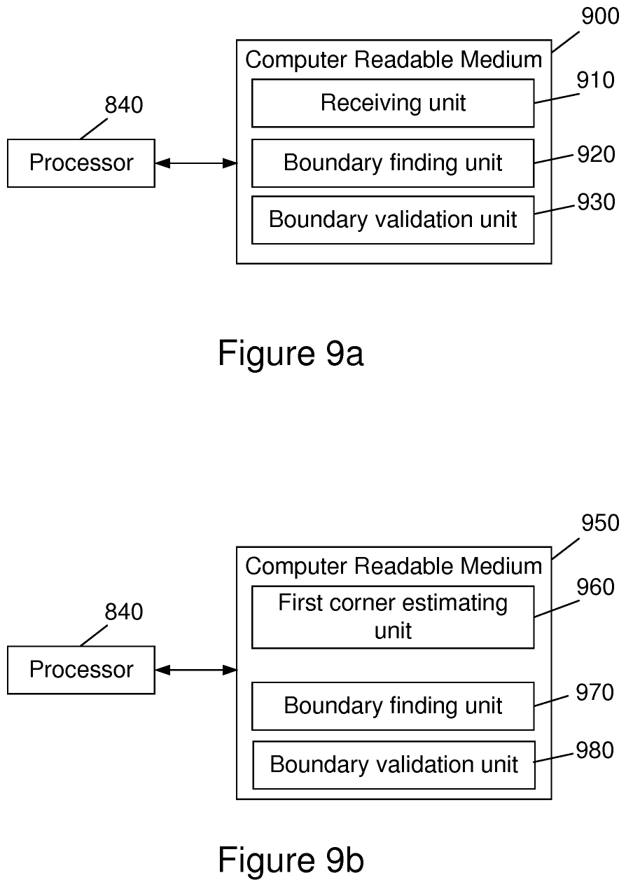

FIG. 9a illustrates a computer readable medium 900 according to some examples. The computer readable medium 900 stores units, with each unit including instructions that, when executed, cause a processor 840 or other processing device to perform particular operations. The computer readable medium 900 includes a receiving unit 910 including instructions that, when executed, cause a processing device 840 to receive an image comprising a document and a background area. The computer readable medium 900 also includes a boundary finding unit 920 including instructions that, when executed, cause the processing device 840 to find a candidate location of a boundary of the document. The computer readable medium 900 also includes a boundary validation unit 920 including instructions that, when executed, cause the processing device 840 to validate the candidate location of the boundary of the document. In some examples the receiving unit 910 may cause the processor to operate in accordance with operation 310 of method 300 or operation 410 of method 400. In some examples the boundary finding unit 920 and boundary validation unit 930 may cause the processor to operate in accordance with operations 220 and 230 of method 200, operations 320 and 330 of method 300, or operations 420 and 430 of method 400. The units of the computer readable medium 900 may cause a processing device 840 to operate in accordance with any of the examples described herein.

FIG. 9b illustrates a computer readable medium 950 according to some examples. The computer readable medium 950 stores units, with each unit including instructions that, when executed, cause a processor 840 or other processing device to perform particular operations. The computer readable medium 950 includes a first corner estimating unit 960 including instructions that, when executed, cause a processing device 840 to determine a first estimated position of a corner of a document in a captured image. The computer readable medium 950 also includes a windowing unit 970 including instructions that, when executed, cause the processing device 840 to define a window around the first estimated position. The computer readable medium 950 also includes a second corner estimation unit 980 including instructions that, when executed, cause the processing device 840 to identify a second estimated position of the corner of the document. In some examples the first corner estimating unit 960 may cause the processor to operate in accordance with operation 240 of method 200 or operation 510 of method 500. In some examples the windowing unit 970 may cause the processor to operate in accordance with operation 250 of method 200 or operation 520 of method 500. In some examples the second corner estimation unit 980 may cause the processor to operate in accordance with operation 260 of method 200 or operation 530 of method 500.

The units of the computer readable medium 900 may cause a processing device 840 to operate in accordance with any of the examples described herein.

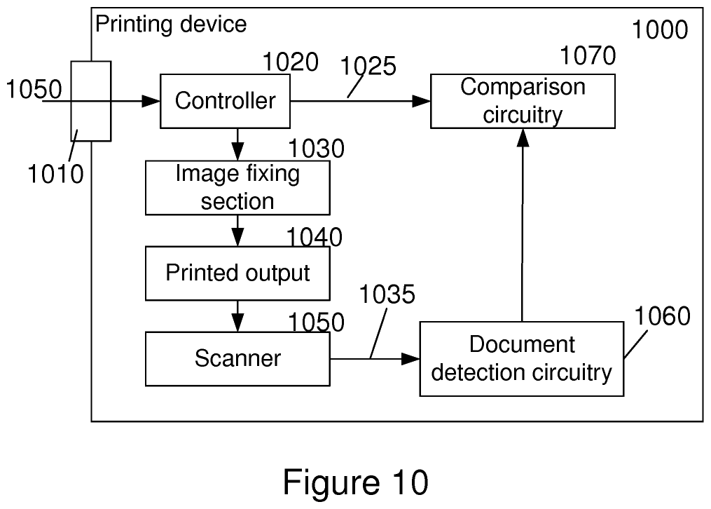

FIG. 10 illustrates a printing device 1000 according to some examples. The arrangement of FIG. 10 is a printing device for applying a 2-dimensional (2D) image to a substrate. The printed output 1040 may be a printed medium that is printed by the printing device 1000.

Print instructions 1005, such as a print job, are received at input 1010. Print instructions 1005 may include a digital description of a document to be printed on a substrate.

The printing device 1000 may include one or more control elements, illustrated as controller 1020, to control the various components of the printing device 1000. The controller 1020 may be implemented in software, hardware, firmware or a combination of these.

The controller 1020 controls an image fixing section 1030 to print or otherwise fix the document to a substrate to generate printed output 1040. The image fixing section 1030 may be, for example, a digital press, offset press, inkjet printer, toner printer, etc.

The printed output 1040 is scanned by scanner 1050, and may subsequently be output from the printing device 1000.

The scanner 1050 outputs a digital representation (a captured image) 1055 of the printed output 1040 to the document detection circuitry. The document detection circuitry may operate in accordance with any example herein to determine a boundary of a document 120 in the captured image 100.

Comparison circuitry 1070 may receive a reference document 1025 from controller 220, based on the document to be printed according to the print instructions 1005. The comparison circuitry 1070 may compare the reference document 1025 with the document 120 in the captured image 100, using the determined boundary of the document 120 in the captured image 100 to align or register the document 120 in the captured image 100 with the reference document 1025.

The comparison circuitry 1070 may determine whether or not there are any defects in the printed output 1040, based on the comparison between the reference image 1025 and the document 120 in the captured image 100.

In some examples a color space conversion may be performed on one or more of the document in the print instructions 1005, the captured image 1055 and/or the reference image. For example, the document in the print instructions 1005 may be received as, or converted to, a CMYK color space. The captured image may be generated by the scanner in a RGB color space. The reference image may be in the CMYK color space, RGB color space or some other color space. The reference image and the captured image may be converted by the comparison circuitry, or prior to arriving at the comparison circuitry 1070, to the same color space to facilitate the comparison.

In some examples, the scanner 1050 may be an in-line scanner.

In FIG. 10, the various components are illustrated as being part of the printing device 1000. However, in some examples, some components may be provided separately from the printing device, in different functional processing units, for example.

In some examples the printing device 1000 may be a press, such as a commercial press. In some examples, in order to maintain high throughput, the printed output may be moving at high speed (e.g. around 1280 mm/s). In some examples, the document detection circuitry 1060 and comparison circuitry 1070 may be arranged to operate at a speed that is consistent with the speed of the printing process. Efficient processing by the document detection circuitry 1060 and the comparison circuitry 1070 may assist in operating at a speed consistent with the printing process while avoiding a significant cost increase associated with hardware having greater processing capability.

In some examples, the handling of the printed output 1040 may be dependent on whether or not any defects are determined to be present by the comparison circuity 1070. For example, if a defect is determined to be present, the output may be paused until a user has intervened, or an output path of the printed output 1040 may be changed.

In some examples of printing device 1000, the printed output 1040 may be moved and controlled by medium handling elements, such as rollers, conveyor belts, etc. In some examples, a maximum expected skew of the document 120 in the captured image 100 may be predicted based on the medium handling elements. For example, in some cases a skew in the printed output 1040 exceeding a threshold value (e.g. of around 3 degrees) may lead to the medium jamming. In such a case, the skew of the document 120 in the captured image 100 may be expected to be less than the threshold value (e.g. 3 degrees). In some examples, parameters of the document detection/boundary detection method may be set based on the threshold (maximum expected) skew. For example, the sizes of the windows in one or more of operations 250, 260, 520 and 530 of methods 200 and 500 may be set based on the threshold (maximum expected) skew.

may be set based on the assumption that the skew of the document in the captured image is less than the threshold skew.

Examples herein refer to a captured image. The method of producing the image is not particularly limited, and the image may be received (as a received image) from any image source that produces suitable images.

Throughout the description and claims of this specification, the words “comprise” and “contain” and variations of them mean “including but not limited to”, and they are not intended to (and do not) exclude other components, integers or operations. Throughout the description and claims of this specification, the singular encompasses the plural unless the context implies otherwise. In particular, where the indefinite article is used, the specification is to be understood as contemplating plurality as well as singularity, unless the context implies otherwise.

Features, integers or characteristics described in conjunction with a particular aspect or example are to be understood to be applicable to any other aspect or example described herein unless incompatible therewith. All of the features disclosed in this specification (including any accompanying claims, abstract and drawings), and/or all of the operations of any method or process so disclosed, may be combined in any combination, except combinations where at least some of such features and/or operations are mutually exclusive. Examples are not restricted to the details of any foregoing examples. The Examples may extend to any novel one, or any novel combination, of the features disclosed in this specification (including any accompanying claims, abstract and drawings), or to any novel one, or any novel combination, of the operations of any method or process so disclosed.

Examples provide a method comprising: receiving an image comprising a document and background area; finding a candidate location of a boundary between the document and the background area; and checking a validity of the candidate location of the boundary, based on pixel values around the candidate location of a first channel of the image, and pixel values around the candidate location of at least one other channel of the image, wherein the at least one other channel is different from the first channel.

In some examples, checking the validity of the candidate location of the boundary is based on at least one of: determining a first statistic of the pixel values around the candidate location of the first channel, and comparing the first statistic to a background statistic associated with the background area; and determining at least one other statistic of the pixel values around the candidate location of the at least one other channel, and comparing the at least one other statistic to at least one other background statistic associated with the background area.

In some examples, the first statistic is based on a luminance of the pixel values around the candidate location.

Some examples further comprise finding a new candidate location of the boundary if the candidate location is determined to be invalid.

In some examples, the boundary is a corner or an edge.

In some examples, wherein the candidate location is one of a plurality of candidate locations, and the method further comprises finding the plurality of candidate locations, and checking the validity of each of the plurality of the candidate locations, wherein the plurality of candidate locations defines a bounding box around the document.

In some examples, the candidate location of the boundary between the document and the background area is found based on a third channel.

In some examples, the third channel is the same as the first channel.

Examples provide a method comprising: receiving an image comprising a document and background area; finding a candidate location of a boundary between the document and the background area based on pixel values of a first channel; and checking a validity of the candidate location of the boundary, based on pixel values around the candidate location of at least a second channel of the image, wherein the first channel is different from the second channel.

In some examples, checking the validity of the candidate location of the boundary is based on at least one of: determining a first statistical measure of the pixel values around the candidate location of the first channel, and comparing the first statistical measure to a background statistical measure associated with the background area, and determining at least one other statistical measure of the pixel values around the candidate location of the at least second channel, and comparing the at least one other statistical measure to at least one other background statistic associated with the background area.

In some examples, the validity of the candidate location of the boundary is checked based on a third channel.

In some examples, a third channel is the same as the first channel.

Examples provide an apparatus comprising: image receiving circuitry to receive an image, the image comprising a document and background area; document location circuitry to find a candidate location of a boundary between the document and the background area based on pixel values of a first channel; and validation circuitry to validate the candidate location of the boundary, based on pixel values around the candidate location of at least a second channel of the image, wherein the first channel is different from the second channel.

In some examples, the validation circuitry is to perform at least one of: determine a first statistical measure of the pixel values around the candidate location of the first channel, and compare the first statistical measure to a background statistical measure associated with the background area; and determine at least one other statistical measure of the pixel values around the candidate location of the at least second channel, and comparing the at least one other statistical measure to at least one other background statistic associated with the background area.

Examples provide a non-transitory computer readable medium having stored thereon instructions that when executed, cause a processor to perform the method according to some examples.

Examples provide a method comprising: identifying a first estimated position of a corner of a document, the document inside an image; defining a window around the first estimated position, wherein the area of the window is smaller than the area of the image; identifying a second estimated position of the corner of the document based on a portion of the image inside the window.

In some examples, the first estimate is identified based on at least one discontinuity in a statistical measure of intensity of a plurality of rows and columns of the image.

In some examples, the second estimated position is identified based on at least one discontinuity in a statistical measure of intensity of a plurality of rows and columns of the portion of the image inside the window.

Some examples further comprise: applying a corner detection method inside the window, resulting in a plurality of possible corner locations; and determining a first subset of potential corner locations from the plurality of potential corner locations.

Some examples further comprise: defining a location of the corner of the document based on a comparison of the second estimated position and the first subset of possible corner locations.

In some examples, the corner detection method is based on a determination of at least a partial derivative of the intensity of pixels inside the window.

In some examples, the corner detection method is based on at least one of a Harris corner detector, a SUSAN corner detector, and a minimum eigenvalue corner detector.

In some examples, determining the first subset of possible corner locations comprises: determining a strength of each possible corner location and selecting the first subset based on the strength.

In some examples, defining the location of the corner of the page comprises comparing the distance from each of the first subset of possible corner locations to the second estimate the location of the corner.

Some examples comprise an apparatus comprising: first corner estimate circuitry to determine a first estimated position of a corner of a document, the document inside a image; windowing circuitry to define a window around the first estimated position, wherein the area of the window is smaller than the area of the image; and second corner estimate circuitry to identify a second estimated position of the corner of the document based on a portion of the image inside the window.

Some examples further comprise corner detection circuitry to apply a corner detection method inside the window, resulting in a plurality of possible corner locations;

and to determine a first subset of potential corner locations from the plurality of potential corner locations.

In some examples, the corner detection method is based on a determination of at least a partial derivative of the intensity of pixels inside the window.

In some examples, the corner detection circuitry is to determine the first subset of possible corner locations by determining a strength of each possible corner location and selecting the first subset based on the strength.

In some examples, the apparatus further comprises: document corner defining circuitry to define the location of the corner of the page based on a comparison the distance from each of the first subset of possible corner locations to the second estimate the location of the corner.

Some examples comprise a non-transitory computer readable medium having stored thereon instructions that when executed, cause a processor to perform the method of some examples.

1. A method comprising:
receiving an image comprising a document and background area;
finding a candidate location of a boundary between the document and the background area; and
checking a validity of the candidate location of the boundary, based on pixel values around the candidate location of a first channel of the image, and pixel values around the candidate location of at least one other channel of the image, wherein the at least one other channel is different from the first channel.

2. The method according to claim 1, wherein checking the validity of the candidate location of the boundary is based on at least one of:
determining a first statistic of the pixel values around the candidate location of the first channel, and comparing the first statistic to a background statistic associated with the background area; and
determining at least one other statistic of the pixel values around the candidate location of the at least one other channel, and comparing the at least one other statistic to at least one other background statistic associated with the background area.

3. The method according to claim 2, wherein the first statistic is based on a luminance of the pixel values around the candidate location.

4. The method according to claim 1, further comprising finding a new candidate location of the boundary if the candidate location is determined to be invalid.

5. The method according to claim 1, wherein the boundary is a corner or an edge.

6. The method according to claim 1, wherein the candidate location is one of a plurality of candidate locations, and the method further comprises finding the plurality of candidate locations, and checking the validity of each of the plurality of the candidate locations, wherein the plurality of candidate locations defines a bounding box around the document.

7. The method according to claim 1, wherein the candidate location of the boundary between the document and the background area is found based on a third channel.

8. The method according to claim 7, wherein the third channel is the same as the first channel.

9. A method comprising:
receiving an image comprising a document and background area;
finding a candidate location of a boundary between the document and the background area based on pixel values of a first channel; and
checking a validity of the candidate location of the boundary, based on pixel values around the candidate location of at least a second channel of the image, wherein the first channel is different from the second channel.

10. The method according to claim 9, wherein checking the validity of the candidate location of the boundary is based on at least one of:
determining a first statistical measure of the pixel values around the candidate location of the first channel, and comparing the first statistical measure to a background statistical measure associated with the background area, and
determining at least one other statistical measure of the pixel values around the candidate location of the at least second channel, and comparing the at least one other statistical measure to at least one other background statistic associated with the background area.

11. The method according to claim 9, wherein the validity of the candidate location of the boundary is checked based on a third channel.

12. The method according to claim 11, wherein the third channel is the same as the first channel.

13. An apparatus comprising:
image receiving circuitry to receive an image, the image comprising a document and background area;
document location circuitry to find a candidate location of a boundary between the document and the background area based on pixel values of a first channel; and
validation circuitry to validate the candidate location of the boundary, based on pixel values around the candidate location of at least a second channel of the image, wherein the first channel is different from the second channel.

14. The apparatus of claim 13, wherein the validation circuitry is to perform at least one of:
determine a first statistical measure of the pixel values around the candidate location of the first channel, and compare the first statistical measure to a background statistical measure associated with the background area; and
determine at least one other statistical measure of the pixel values around the candidate location of the at least second channel, and comparing the at least one other statistical measure to at least one other background statistic associated with the background area.

15. A non-transitory computer readable medium having stored thereon instructions that when executed, cause a processor to perform the method of claim 1.
